(19) United States
(12) Patent Application Publication
(10) Pub. No.: US 2022/0408797 A1
(43) Pub. Date: Dec. 29, 2022

(54) Smoking Article and Method for Manufacturing a Smoking Article

(71) Applicant: JT International SA, Geneva (CH)

(72) Inventors: Daniel Lickefeld, Riol (DE); Miguel Soriano, Geneva (CH)

(73) Assignee: JT International SA, Geneva (CH)

(21) Appl. No.: 17/780,257

(22) PCT Filed: Nov. 25, 2020
(86) PCT No.: PCT/EP2020/083298

§ 371 Date: May 26, 2022

(30) Foreign Application Priority Data
Nov. 29, 2019 (EP) 19212545.8

(51) Int. Cl. A24C 5/60

(52) U.S. Cl. CPC A24C 5/601

(57) ABSTRACT

A smoking article includes a rod including smokable material wrapped by a wrapper, a mouthpiece connected to an end of the rod, wherein a machine-readable code is printed onto an outer surface of the wrapper, the printed machine-readable code being proximate a distal edge of the wrapper. A method for manufacturing a smoking article is also provided.

### CROSS-REFERENCE TO RELATED APPLICATIONS

The present application is a national phase entry under 35 U.S.C. § 371 of International Application No. PCT/EP2020/083298, filed Nov. 25, 2020, published in English, which claims priority to European Application No. 19212545.8 filed Nov. 29, 2019, the disclosures of which are incorporated herein by reference.

### FIELD OF THE INVENTION

The invention relates to a smoking article comprising a rod comprising smokable material wrapped by a wrapper and a mouthpiece connected to an end of the rod.

### BACKGROUND OF THE INVENTION

Often printed machine-readable codes are used on packaging for smoking articles, such as cigarettes. These printed machine-readable codes generally contain additional information for the consumer. For example, the printed machine-readable codes often contain an URL leading to a website with additional information for the consumer, such as product information regarding the smoking article.

Providing printed machine-readable codes on smoking articles or their packaging is problematic since their information may be accessed by an undesired population such as non-smokers and more particularly minors. This may occur due to littering. Efforts have been made to prevent such unauthorized access by requiring the consumer to register and verify his/her age before accessing the content. However, it is desirable to provide an additional layer of security to prevent undesirable access to the content of the printed machine-readable code.

### BRIEF SUMMARY OF THE INVENTION

It is therefore the objective of this invention to provide a smoking article with a machine-readable code that prevents access to its content to an undesired population. It is also an objective of this invention to provide a machine-readable code that is easy and cost effective to apply, is reliably destroyed during the smoking process and has little impact on the smoking article.

This objective is reached by a smoking article comprising:
a rod comprising smokable material wrapped by a wrapper;
a mouthpiece connected to an end of the rod;

Wherein a machine-readable code is printed onto an outer surface of the wrapper, the printed machine-readable code being proximate a distal edge of the wrapper.

The term distal edge refers to the end of the wrapper which is arranged away from the consumer's mouth. For a conventional cigarette, the distal edge of the wrapper is arranged at the lit end of the cigarette. The term proximal edge refers to the end of the wrapper which is arranged towards the consumer's mouth. For a conventional cigarette, the proximal edge of the wrapper is arranged at the filter of the cigarette.

The rod preferably is a tobacco rod. Preferably, the smokable material is tobacco. The mouthpiece preferably is a filter rod comprising a filtration material. Preferably, the filtration material is cellulose acetate, paper or polylactic acid. The filter rod may also be wrapped by a second wrapper. Preferably, the second wrapper is a tipping paper.

The machine-readable code is any kind of encoded information on the wrapper that can be read by a machine. The machine reads the code with a code reader. The code reader may be an optical reader, e.g. a camera or a laser, preferably equipped with a processing unit to process and decode the information from the code, wherein the processing unit preferably is also able to transmit the decoded information. The machine-readable code preferably is a 1-dimensional or 2-dimensional optical code. Optical codes consist of lines and/or dots of different width or size with blank spaces enclosed between them, wherein the lines and/or dots having an as high as possible contrast to the blank spaces. Preferably, the machine-readable code is a code selected from one of the following code types: EAN, UPC, IAN, JAN, ITF, 2/5i, Code39, Code93, Codabar, Code128 Codablock, Code49, PDF417, QR-Code, DataMatrix, MaxiCode, Aztec-Code, JAB-Code, Han Xin-Code, Dot-Code A, Snowflake code, BeeTagg Composite-Code, RM4SCC.

The position of the code is proximal to the distal edge of the wrapper. Preferably, the position of the code is nearer to the distal edge of the wrapper than to the proximal edge of the wrapper.

This ensures that the code is destroyed during the smoking process even when the smoking process is interrupted. This is of special importance to prevent unintended access to the information contained in the code. Printing the code onto the wrapper material denotes a very simple and effective way to equip the smoking article with a machine-readable code. In contrast to an affixation of additional material comprising the code, any further material or glue aside from the ink itself can be omitted. This is also of high importance as it simplifies the manufacturing process and also minimizes any deterioration of the smoking articles properties.

According to another embodiment, the machine readable code is printed with ink comprising ground tobacco. In another embodiment, the machine-readable code may be printed using an ink that contains tobacco material, preferably ground tobacco material. Due to the tobacco contained in the ink, the ink has a positive impact on the taste of the smoke of the smoking article when the pint comprising the ink is combusted. Tobacco as a natural colorant in the ink promotes the natural character of the smoking article and increases consumer acceptance of prints on the wrapper compared to an artificial colorant. Also smaller particles of the tobacco plant, which are not suitable for use a smokable material, may be used in the ink. This increases the yield from the tobacco plant material and less tobacco plant material is wasted.

Preferably, the amount of ground tobacco in the ink is between 1-50 weight %. With such an amount of ground tobacco in the mixture the correct viscosity of the ink and a sufficient color intensity can be ensured.

According to another embodiment, the ink comprises ground tobacco and a humectant. Alternatively, the ink comprises ground tobacco and water. The humectant preferably is propylene-glycol and/or glycerin. Both substances are widely used in tobacco. Both substances have only little impact on the taste of the smoking article, when being burnt together with the wrapper and the rod. Therefore, the humectant of the ink does not deteriorate the taste of the smoking product to which the ink is applied.

The ink may also contain solvents, pigments, dyes, resins, lubricants, solubilizers, surfactants, particulate matter and/or fluorescents. Preferably, the ink also contains water, humectant, solvents, pigments, dyes, resins, lubricants, solubilizers, surfactants, particulate matter and/or fluorescents. With dyes, resins and/or particulate matter the color, the color intensity and the hiding power of the ink can be optimized. By adding solvents, resins, lubricants, solubilizers and/or surfactants the rheology of the ink can be optimized. Such an optimization is of special interest for adapting the ink to specific printing machinery. By adding a fluorescent the print can be read or read better under irradiation with UV-light.

The ink may have a viscosity comprised between 50 and 350 dPas measured with falling-rod viscometer at 25° C. The ink may have a density comprised between 0.8 g/cm³ and 1.5 g/cm³. Preferably, the ink dries physically by absorption.

The coloring agent in the ink is the ground tobacco. By using ground tobacco, the taste of the smoking product is not negatively affected by the ink. The tobacco containing ink even complements the taste of the smoking product. Due to the tobacco content, the ink enhances the tobacco taste when the ink is combusted.

Preferably, the ingredients of the ink are mixed to obtain the ink. The ink denotes a suspension of the ground tobacco in humectant and/or water. After mixing all ingredients a stirring step is preferred to ensure proper mixing of all ingredients in the ink which ensures a homogeneous application of the ink.

The color intensity of the ink can be adapted by selection of the tobacco type and concentration. The higher the tobacco concentration in the ink, the darker the color of the ink will be. By using a darker type of tobacco also a darker ink color can be obtained. Such darker tobacco types preferably are Burley tobacco, dark fire-cured tobacco and dark air-cured tobacco. With such darker tobacco types a darker ink color and also higher contrast to a light-colored wrapper can be obtained.

According to another embodiment, the ground tobacco comprises a maximum particle size of about 30 μm. Preferably, the maximum particle size is between 25 and 35 μm. Even more preferred, the maximum particle sizes is between 28 and 32 μm. Most preferred, the maximum particle size is 30 μm. With the maximum particle size an even color distribution in the print is achieved. With more coarsely ground tobacco the individual tobacco particles may be visible in the print image, which is undesirable. With this maximum particle size also a sufficient resolution in the print image is achieved. This is of high importance to ensure the machine-readability of the code. Preferably, the particles are as small as possible, as with smaller particles the abrasion of the printing rollers is reduced.

According to another embodiment, the wrapper, being the background of the printed machine-readable code, is of light color and the machine-readable code, being the foreground, is of dark color. As the wrapper is typically of white color, this coloring ensures the least amount of ink to be needed for the print. In this way only the dark parts of the code need to be printed with the ink onto the wrapper, wherein the other parts of the code remain uncoated having the color of the wrapper. Also only one ink color is needed to generate the two colored printed code. This makes the whole printing process much easier, faster and more cost effective. It is also possible to print the code onto colored wrappers. But in this case the contrast between the foreground and the background has to be sufficient. Preferably, the foreground is black and the background is white.

According to another embodiment, the wrapper, being the background of the printed machine-readable code, is of dark color and the machine-readable code, being the foreground, is of light color. This embodiment is particularly advantageous if a smoking article comprising a dark colored wrapper is used. For example this could be a cigarillo. In this way only the light parts of the code need to be printed with the ink onto the wrapper, wherein the other parts of the code remain uncoated having the color of the wrapper. Also only one ink color is needed to generate the two colored printed code. This again makes the whole printing process much easier, faster and more cost effective.

According to another embodiment, the symbol contrast between the machine-readable code and the wrapper is at least of grade C, preferably grade B, most preferred grade A. The contrast can be determined with up to 8 different parameters according to ANSI and ISO barcode print quality documents. The contrast grades given here refer to the symbol contrast (SC). The symbol contrast is the difference between the highest reflectance value (Rmax) and the lowest reflectance value (Rmin) anywhere in the scan reflectance profile of the code. The higher the SC value the better the contrast. Rather than using the absolute value, the symbol contrast is graded as follows:

SC=Rmax−Rmin

SC≤70%=Grade A

SC≤55%=Grade B

SC≤40%=Grade C

SC≤20%=Grade D

SC<20%=Grade F

This parameter can be measured using ISO method ISO/IEC 15416:2016 for linear bar codes and using ISO method ISO/IEC 15415:2011 for two-dimensional symbols. With the sufficient contrast of at least grade C, preferably grade B, most preferred grade A, the machine-readability of the code is provided. This machine-readability is then independent from the actual colors used as foreground and background colors. Therefore, every color combination for foreground and background may be used as long as the contrast between the two colors is at least grade C, preferably grade B, most preferred grade A.

According to another embodiment, machine-readable code is a QR-code or a barcode. A QR-code is a code type, which is very easy to read due to its three tracking boxes in three of its square corners. Also a QR-code is readable with most smartphone cameras. This makes the code readable to the average consumer. Also a QR-code can be designed with a relatively coarse resolution. A QR-code can also be designed to have a very good error correction, which ensures readability even if certain parts of the code are damaged. A barcode is a code type, which is broadly used. Also barcodes are readable with most smartphone cameras. This makes the code readable to the average consumer. Also a barcode can be designed with a relatively coarse resolution, which makes it easy to print.

Preferably, the QR-code is a version 4 or smaller QR-code. This includes version 3, 2 and 1. Version 4 comprises a matrix of 33×33 pixels. Version 3 comprises a matrix of 29×29 pixels. Version 2 comprises a matrix of 25×25 pixels. Version 1 comprises a matrix of 21×21 pixels. Preferably, the QR-code is a micro QR-code. Preferably, the micro QR-code comprises a matrix of 17×17 pixel, which denotes the micro QR-code version M4. More preferred, the micro QR-code comprises a matrix of 15×15 pixels, which denotes the micro QR-code version M3. The micro QR-code are smaller than conventional QR-codes. This makes them easier to position on a relatively small smoking article.

According to another embodiment, the machine-readable code comprises a margin around the code having either the color of the background or the foreground. To enhance readability of a two-dimensional code it is advisable to leave a margin around the code. Preferably, the margin has the same color as either of the background or foreground. This margin will lead to better readability of the code.

According to another embodiment, the machine-readable code is positioned less than 5 mm, preferably less than 1 mm, most preferred less than 0.5 mm, from the distal edge of the wrapper. By positioning the code that close to the distal edge of the wrapper, the code is placed at the lit end of the smoking article. This position ensures that the code is destroyed already during the first puff. This is of high importance in scenarios in which the consumer might put out the smoking article already after the first puff and discard it. This position of the code ensures, that also in such scenarios the code is destroyed and is not readable anymore. The remaining distance of the machine-readable code to the distal edge ensures room for the margin around the code. It also promotes the readability of the code.

According to another embodiment, the smoking article comprises more than one machine-readable code. By using more than one code, the same encoded information could be arranged at different positions on the smoking article. Also each code could contain individual information so that with multiple codes on the smoking article multiple sets of information can be arranged on the smoking article. For example, two or more identical machine-readable codes could be arranged circumferentially around the smoking article at the distal edge. In this way, the consumer does not need to rotate the smoking article in order to access one of the codes while all codes are still reliably destroyed when the smoking article is lit. Also it is possible to arrange two or more non-identical machine-readable codes circumferentially around the smoking article at the distal edge. In this way, more information can be provided on the smoking article, while all codes are still reliably destroyed when the smoking article is lit.

The objective of the invention is also reached by a method for manufacturing a smoking article comprising a rod comprising smokable material wrapped by a wrapper, a mouthpiece connected to the rod, and a machine-readable code printed on an outer surface of the wrapper, wherein the machine-readable code is proximate to a distal edge of the wrapper comprising the steps:
printing of machine-readable codes onto a surface of a continuous wrapper material wherein the machine-readable codes are positioned in a defined code distance to each other;
forming a continuous rod by wrapping a smokable material with the continuous wrapper material, so that the surface containing the printed machine-readable code does not contact the smokable material;
forming rods by cutting the continuous rod at defined cut positions in relation to the machine-readable codes;
assembling a mouthpiece to each rod.

The print process is carried out with a conventional printing machinery for printing on continuous materials which are fed through the printing machinery. Preferably, the continuous wrapper material is a web. Preferably, the printing machinery comprises a print roller, which is coated with the ink and rolled over the surface of the continuous wrapper material. The codes are positioned on the continuous wrapper material with a specific code distance between each neighboring codes. The code distance is measured along a feeding direction of the continuous wrapper material in the machine from the end of a first code to the beginning of the neighboring code. Preferably, the code distance is selected so that after cutting the continuous wrapper material each wrapper, having a wrapper length, comprises the desired number of codes. If for example each individual wrapper is designed to have one code on its surface, the code distance plus the code width will equal the wrapper length.

Subsequently, a continuous rod is formed by wrapping a smokable material with the continuous wrapper material comprising the printed codes. The codes are arranged on the surface of the continuous wrapper material, which faces away from the smokable material, in other words the print is arranged on the outer surface of the continuous wrapper material wrapped around the smokable material.

The continuous rod is then cut at defined cut positions thereby forming individual rods. The cut distance, which is the distance between two neighboring cut positions along the feeding direction, are determined in relation to the codes and the code distance. If each rod is to have one code, the cut distance equals the code distance plus the code width. The cut positions are aligned at the codes. Preferably, the cut position is arranged at a specific cut-code distance from the center of the code. Preferably this cut-code distance equals the distal edge distance plus half the code width. Preferably, the distal edge distance is less than 5 mm, preferably less than 1 mm, most preferred less than 0.5 mm.

Finally, a filter rod is assembled to the previously formed rod. Preferably, the filter rod is assembled to the end of the rod having no code. This aligns the code at the distal end of the smoking article.

According to another embodiment, in advance of the method of claim 11 an ink for printing the machine-readable codes is mixed of at least ground tobacco and a humectant and/or water.

Preferably, the mixture is stirred to ensure homogeneous mixing of the ingredients. Preferably, further ingredients like solvents, pigments, dyes, resins, lubricants, solubilizers, surfactants, particulate matter and/or fluorescents if used are also incorporated into the mixture in this mixing step.

After mixing of the ink, code is applied to a continuous wrapper material with the previously mixed ink in a print process.

According to another embodiment, the cutting position of the continuous rod is determined by sensing the machine-readable code position with a sensor and adding an adjustable offset to the code position. By this technique additional alignment marks, which are normally used to align a material at specific cut positions, can be omitted. This means, that the additional printing of alignment marks can be omitted, which makes the whole manufacturing process easier. Also alignment mark ink is not needed anymore. This makes elaborate processes to hide such alignment marks and/or to prohibit negative taste impact of the alignment mark ink obsolete.

According to another embodiment, the machine-readable codes are printed onto the continuous wrapper material in pairs, wherein each code pair consists of two codes positioned next to each other along the feeding direction of the continuous wrapper material with a spacing between the two codes which is smaller than the defined distance between the code pairs. By printing the codes in pairs onto the continuous wrapper material a more effective production process can be used, in which a double length rod is formed and then is effectively processed into two smoking articles as described in the following. Reference regarding this process is also made to the figure description of FIG. 3 for a more detailed description of this effective production process.

According to another embodiment, the continuous rod is cut at a cut position between the two codes of a pair. In this way a double length rod is formed. Each double length rod comprises two codes, wherein a code is positioned at each end of the double rod.

According to another embodiment the continuous rod is cut at a second cut position in the middle between two code pairs. This second cut position is preferably used in addition to the previously described first cut position. Preferably, the cut at this second cut position is made after the cut at the first cut position. This means, that first the continuous rod is cut at the first cut position into double rods and after that each double rod is cut at the second cut position into individual rods. A double filter rod can then be affixed to two neighboring rods at the respective ends of the rods generated by the cut at the second cut position. Finally, after connecting the ends of the double filter rod to the two rods (e.g. with a tipping paper), the double filter rod is cut in the middle forming two individual smoking articles. In this way two smoking articles can be manufactured at the same time with one machine, which makes the manufacturing process much more efficient.

### BRIEF DESCRIPTION OF THE DRAWINGS

Further advantages, objectives and features of the present invention will be described, by way of example only, in the following description with reference to the appended figures. In the figures, like components in different embodiments can exhibit the same reference symbols. The figures show:

FIG. 1 a general view of a smoking article 1 comprising a code 10;

FIG. 2 a detailed view of the wrapper 6 with the code 10;

FIG. 3 a schematic view of the continuous rod 22 comprising codes 10;

FIG. 4 a schematic view of the continuous rod 22a comprising code pairs 30.

### DETAILED DESCRIPTION

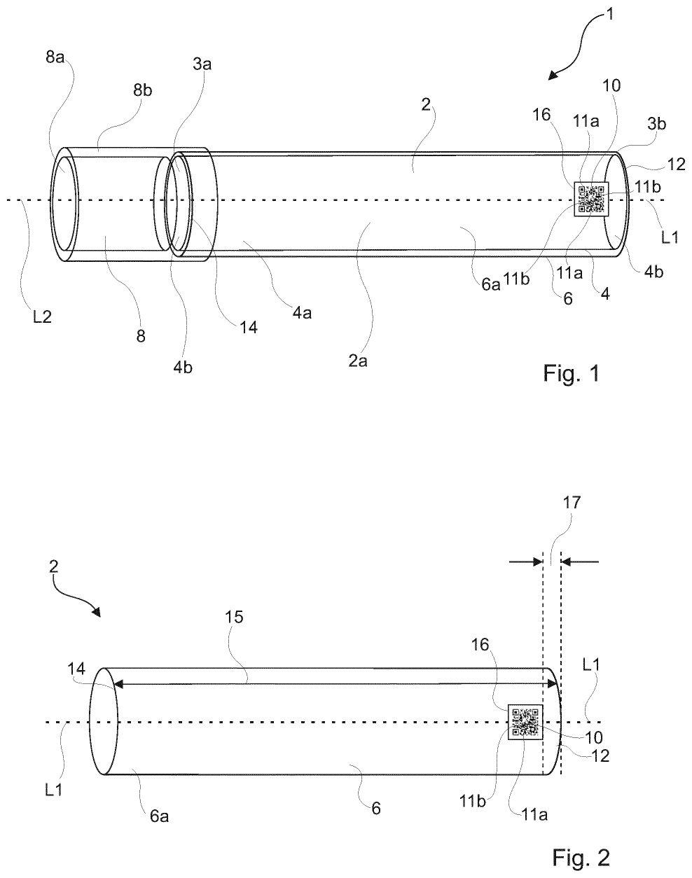

FIG. 1 shows a general view of a smoking article 1. The smoking article 1 comprises a rod 2 and a filter rod 8. The rod 2 comprises a smokable material 4 having a cylindrical shape 2a. The cylindrical shape 2a consists of a lateral area 4a of the smokable material 4 and two circular base areas 4b being parallel to each other and being perpendicular to the lateral area 4a. A wrapper 6 is wrapped around the smokable material 4. The wrapper 6 covers the whole lateral area 4a of the smokable material 4 and leaves the base areas 4b unwrapped. A longitudinal axis L1 of the rod 2 is arranged parallel to the lateral area 4a and perpendicular to the base areas 4b and intersects with the base areas 4b at their respective center.

A filter rod 8, having a cylindrical shape with a longitudinal axis L2, is arranged at a proximal end 3a of the rod 2. The proximal end 3a of the rod 3 denotes the end 3a, to which the filter rod 8 is arranged. The filter rod 8 is arranged to the rod 2 so that the longitudinal axes L1, L2 are congruent. Preferably, the filter rod 8 comprises a filter segment 8a of cylindrical shape and a tipping paper 8b wrapped around the lateral area of the filter segment 8a.

A machine-readable code 10 is arranged on the outer surface 6a of the wrapper 6. The outer surface 6a is directed away from the smokable material 4. The code 10 is arranged at the distal end 3b of the rod 2. The distal end 3b is the lit end of the rod 2. The wrapper 6 comprises a distal edge 12, which is arranged at the distal end 3b of rod 2. The code 10 is arranged near the distal edge 12 of the wrapper 6. The code 10 has a rectangular shape. The code comprises a margin 16 surrounding the code 10 at its outer edges 11a, 11b. Two parallel outer edges 11a of the code 10 are parallel to the longitudinal axis L1.

FIG. 2 shows a detailed view of the wrapper 6 with the code 10. The wrapper 6 has a length 15 along the longitudinal axis L1. The code 10 is arranged at a distal edge distance 17 from the distal edge 12 of the wrapper 6. The distal edge distance 17 is smaller than 5 mm, preferably less than 1 mm, most preferred less than 0.5 mm.

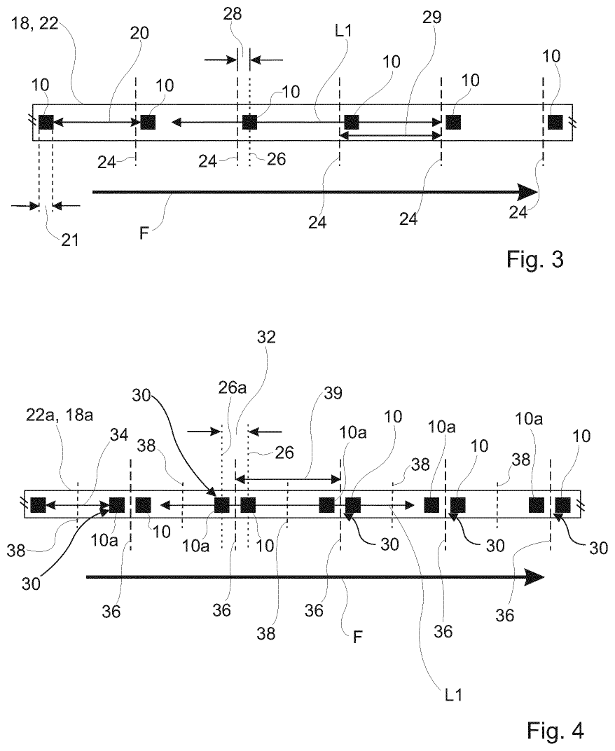

FIG. 3 shows a schematic view of the continuous rod 22 comprising codes 10. The continuous rod 22 comprises a continuous wrapper material 18 wrapped around continuous smokable material. The continuous rod 22 is an intermediate good in the smoking article 1 manufacturing process. The continuous rod 22 is fed through a machinery in a feeding direction F. The feeding direction is parallel to the later longitudinal axis L1 of the continuous rod 22. The codes 10 are arranged on the continuous wrapper material 18 at a code distance 20 to each other. The code distance 20 denotes the length 15 of the wrapper 6 minus the code width 21 measured in the feeding direction F. The continuous rod 22 is cut into individual rods 2, each having a code 10, at cut positions 24. Each cut position 24 is aligned at the neighboring code 10. The cut position 24 is distanced from the center 26 of the code 10 by a cut-code distance 28. The cut positions 24 are distanced from each other by the cut distance 29, which equals the length 15 of the wrapper 6 along the longitudinal axis L1.

FIG. 4 shows a schematic view of the continuous rod 22a comprising code pairs 30. Each code pair comprises two machine-readable codes 10, 10a. The two codes 10, 10a of a code pair 30 are distanced to each other by the intra-pair distance 32, which extends from the center 26 of the first code 10 to the center 26a of the second code 10a of a code pair 30. The second code 10a is arranged, as the first code 10, parallel to the longitudinal axis L1 with two of its outer edges 11a. The two codes 10, 10a are arranged parallel to each other.

The continuous rod 22a with the code pairs 30 is used in a standard, but more efficient production method for smoking articles 1, which is briefly described in the following. At first a continuous wrapper material 18a is wrapped around continuous smokable material. The obtained continuous rod 22a is then cut at a first cut position 36 into double rods, each having the double length of an individual rod 2 and comprising a double wrapper. In the subsequent process, the double rod is then cut in the middle into two individual rods 2 of the same length at a second cut position 38. The two rods 2 are then spaced from each other along the longitudinal axis L1 and a double filter segment, having the double length of an individual filter segment 8a, is inserted between the two rods 2 and affixed to both rods 2, which face each other with their respective proximal ends 3a. The double filter segment is then wrapped in a double tipping paper which is glued at its seam and thereby affixes the double filter rod to both rods 2. In the final step, the double filter rod is cut perpendicular to the longitudinal axis L1 in its middle with a third and final cut. In this way two individual smoking articles 1 are formed with their respective distal ends 3b facing away from each other and their respective proximal ends 3a facing towards each other.

The first cut position 36 is arranged between the two codes 10, 10a of a code pair 30. The first cut position 36 is preferably arranged in the very middle between the two codes 10, 10a. This will result in equal distal edge distances 17, of the code 10 on the wrapper 6 for each individual rod 2. The first cut positions 36 are distanced by the first cut distance 39, which equals the double length of the rod 2 along the longitudinal axis L1.

Each code pair 30 is distance from the neighboring pair 30 by the inter-pair distance 34, which is smaller than the length of the double wrapper. Between two neighboring first cut positions 36 two codes 10, 10a belonging to different code pairs 30 are arranged. In this way, each double wrapper comprises two codes 10, 10a originating from different code pairs after being cut from the continuous wrapper material 18a. The second cut position 38 is located in the very middle between two code pairs 30.

The applicant reserves his right to claim all features disclosed in the application document as being an essential feature of the invention, as long as they are new, individually or in combination, in view of the prior art. Furthermore, it is noted that in the figures features are described, which can be advantageous individually. Someone skilled in the art will directly recognize that a specific feature being disclosed in a figure can be advantageous also without the adoption of further features from this figure. Furthermore, someone skilled in the art will recognize that advantages can evolve from a combination of diverse features being disclosed in one or various figures.

### LIST OF REFERENCE SYMBOLS

1 smoking article

2 rod

2a cylindrical shape

3a proximal end

3b distal end

4 smokable material

4a lateral area

4b base areas

6 wrapper

6a outer surface

8 mouthpiece

8a filter segment

8b tipping paper

10, 10a machine-readable code

11a, 11b outer edges

12 distal edge

14 proximal edge

15 length of wrapper, wrapper length

16 margin

17 distal edge distance

18, 18a continuous wrapper material

20 code distance

21 code width

22, 22a continuous rod

24 cut position

26, 26a center of the code

28 cut-code distance

29 cut distance

30 code pair

32 intra-pair distance

34 inter-pair distance

36 first cut position

38 second cut position

39 first cut distance

L1 longitudinal axis

L2 longitudinal axis

F feeding direction

1. A smoking article comprising:
a rod comprising smokable material wrapped by a wrapper; and
a mouthpiece connected to an end of the rod;
wherein a machine-readable code is printed onto an outer surface of the wrapper, the printed machine-readable code being proximate a distal edge of the wrapper.

2. The smoking article according to claim 1,
wherein the machine readable code is printed with ink comprising ground tobacco.

3. The smoking article according to claim 1,
wherein the ink also contains water, humectant, solvents, pigments, dyes, resins, lubricants, solubilizers, surfactants, particulate matter and/or fluorescents.

4. The smoking article according to claim 2,
wherein the ground tobacco comprises a maximum particle size of 30 μm.

5. The smoking article according to claim 1,
wherein the wrapper, being a background of the printed machine-readable code, is of relatively lighter color than the machine-readable code, being a foreground, which is of relatively darker color.

6. The smoking article according to claim 1,
wherein a symbol contrast between the machine-readable code and the wrapper is at least of grade C.

7. The smoking article according to claim 1,
wherein the machine-readable code is a QR-code or a barcode.

8. The smoking article according to claim 5,
wherein the machine-readable code comprises a margin around the machine-readable code having the same color of either the background or the foreground.

9. The smoking article according to claim 1,
wherein the machine-readable code is positioned less than 5 mm from the distal edge of the wrapper.

10. A method for manufacturing a smoking article comprising a rod comprising smokable material wrapped by a wrapper, a mouthpiece connected to the rod, and a machine-readable code printed on an outer surface of the wrapper, wherein the machine-readable code is proximate to a distal edge of the wrapper, comprising the steps:
printing of machine-readable codes onto a surface of a continuous wrapper material, wherein the machine-readable codes are positioned in a defined code distance to each other;
forming a continuous rod by wrapping a smokable material with the continuous wrapper material, so that the surface containing the printed machine-readable codes does not contact the smokable material;
forming rods by cutting the continuous rod at defined cut positions in relation to the machine-readable codes; and
assembling a mouthpiece to each of the rods.

11. The method according to claim 10,
wherein the step of printing the machine-readable codes uses an ink mixed of at least ground tobacco and a humectant and/or water.

12. The method according to claim 10,
wherein a cutting position of the continuous rod is determined by sensing a position of the machine-readable codes with a sensor and adding an adjustable offset to the position of the machine-readable codes.

13. The method according to claim 10,
wherein the machine-readable codes are printed onto the continuous wrapper material in pairs, wherein each pair consists of two of the machine-readable codes positioned next to each other along a feeding direction of the continuous wrapper material with a spacing between the two codes which is smaller than a defined distance between the pairs.

14. The method according to claim 13,
wherein the continuous rod is cut at a cut position between the two codes of a pair.

15. The method according to claim 14,
wherein the continuous rod is cut at a second cut position in a middle between two of the pairs.

16. The smoking article according to claim 1,
wherein a symbol contrast between the machine-readable code and the wrapper is of grade A.

17. The smoking article according to claim 1,
wherein the machine-readable code is positioned less than 0.5 mm from the distal edge of the wrapper.
